(19) United States
(12) Patent Application Publication
(10) Pub. No.: US 2026/0119162 A1
(43) Pub. Date: Apr. 30, 2026

(54) CANDIDATE COMPONENT COMPATIBILITY ENFORCEMENT WITHIN A SYSTEM

(71) Applicant: U.S. BANK NATIONAL ASSOCIATION, Minneapolis, MN (US)

(72) Inventors: Todd Tao Zhou, San Mateo, CA (US); Sylvia Qing Su, San Jose, CA (US); Zachary Allen McCullough, Milpitas, CA (US); Jin Xing, Boyds, MD (US); Tianqi Jia, Redwood City, CA (US); Rakesh Kumar Gupta, Dublin, CA (US)

(21) Appl. No.: 18/926,599

(22) Filed: Oct. 25, 2024

(51) Int. Cl. G06F 8/71; G06F 16/958

(52) U.S. Cl. CPC G06F 8/71; G06F 16/958

(57) ABSTRACT

Improved compatibility enforcement systems are provided. A candidate component request is received. A component data ingestion protocol adherence status for the candidate component is determined based on applying component data ingestion parameters of configurable adherence parameters to the candidate component output data. A configuration element protocol adherence status is determined based on applying configuration element parameters of the configurable adherence parameters to the candidate component configuration elements. One or more data transformation capabilities of the subject web application system are determined based on data outputs provided by components of a subject web application system. A system compatibility status for the candidate component is determined based on the component data ingestion protocol adherence status, the configuration element protocol adherence status, and the one or more data transformation capabilities of the subject web application system. The subject web application system is configured based on the system compatibility status for the candidate component.

### FIELD

The present application is generally related to systems, methods, apparatuses, and computer program products associated with web application development, and more specifically to enabling component compatibility within a data system.

### BACKGROUND

Developers or consumers who utilize frameworks to build web solutions could benefit from but often lack flexibility, modularity, and extensibility when developing web solutions for end users. Efforts to build such web solutions which both provide data in a visually engaging manner and ensure consistent functionality across multiple platforms can be complex and time consuming and may be ineffective or inefficient versus solutions involving creating bespoke, end-to-end web solutions. Through applied effort, ingenuity, and innovation, these identified deficiencies and problems have been solved by developing solutions that are configured in accordance with the embodiments of the present disclosure, many examples of which are described in detail herein.

### SUMMARY

Embodiments of the present disclosure are directed to an apparatus, computer readable medium, and computer-implemented method for generating, providing, and utilizing a web application system.

An apparatus is provided, the apparatus comprising one or more processors and at least one non-transitory memory having instructions that, when executed by the one or more processors, cause the one or more processors to receive, from a client device, a candidate component request comprising candidate component output data and one or more candidate component configuration elements associated with a candidate component. The instructions, that when executed by the one or more processors, further cause the one or more processors to determine, based on applying one or more component data ingestion parameters of one or more configurable adherence parameters to the candidate component output data, a component data ingestion protocol adherence status for the candidate component. The instructions, that when executed by the one or more processors, further cause the one or more processors to determine, based on applying one or more configuration element parameters of the one or more configurable adherence parameters to the one or more candidate component configuration elements, a configuration element protocol adherence status for the candidate component. The instructions, that when executed by the one or more processors, further cause the one or more processors to determine, based on one or more data outputs provided by one or more components of a subject web application system, one or more data transformation capabilities of the subject web application system. The instructions, that when executed by the one or more processors, further cause the one or more processors to determine, based on the component data ingestion protocol adherence status, the configuration element protocol adherence status, and the one or more data transformation capabilities of the subject web application system, a system compatibility status for the candidate component. The instructions, that when executed by the one or more processors, further cause the one or more processors to configure, based on the system compatibility status for the candidate component, the subject web application system.

According to certain embodiments, the instructions, that when executed by the one or more processors, further cause the one or more processors to receive, from a client device, the one or more configurable adherence parameters representing a plurality of conditions which a target component must meet to ensure compatibility with a first subset of the one or more components of the subject web application system.

According to certain embodiments, the one or more components of the subject web application system are configured to execute one or more sequential data transformations to generate a transformed data element in a preferred data format, wherein the preferred data format is indicated by the one or more component data ingestion parameters.

According to certain embodiments, the instructions, that when executed by the one or more processors, further cause the one or more processors to identify a candidate components set comprising a plurality of candidate components, wherein each candidate component of the candidate components set (i) is associated with a system compatibility status that is positive, and (ii) provides one or more component functions. The instructions, that when executed by the one or more processors, further cause the one or more processors to combine the candidate components set into a single unified component that enables a user to interact with the one or more component functions of each candidate component of the candidate components set via a component function interaction interface.

According to certain embodiments, the instructions, that when executed by the one or more processors, further cause the one or more processors to, responsive to determining that one or more of the component data ingestion protocol adherence status, the configuration element protocol adherence status, or the system compatibility status is negative, reject the candidate component.

According to certain embodiments, the instructions, that when executed by the one or more processors, further cause the one or more processors to generate, based on the one or more configurable adherence parameters, a configurable adherence engine configured to render a user input interface via which a user can configure the one or more configurable adherence parameters.

According to certain embodiments, the instructions, that when executed by the one or more processors, further cause the one or more processors to generate, based on the one or more component data ingestion parameters, one or more configurable universal data exchange formats, wherein the one or more configurable universal data exchange formats comprise one or more entries which can be altered while still retaining compliance with the one or more configurable adherence parameters.

According to certain embodiments, the instructions, that when executed by the one or more processors, further cause the one or more processors to define, based on the one or more configurable adherence parameters, one or more universal component data ingestion hooks configured to provide data in a format that is compatible with a second subset of the one or more components of the subject web application system.

According to certain embodiments, the instructions, that when executed by the one or more processors, further cause the one or more processors to, responsive to determining that the system compatibility status is positive, add the candidate component to the subject web application system.

According to certain embodiments, the instructions, that when executed by the one or more processors, further cause the one or more processors to generate one or more universal component data ingestion hooks to ensure standardized data retrieval and compatibility across APIs associated with the subject web application system.

According to certain embodiments, the configurable adherence parameters comprise one or more combination parameters, and the instructions that, when executed by the one or more processors, further cause the one or more processors to determine, based on applying the one or more combination parameters to the candidate component output data, a combination parameter adherence status for the candidate component with respect to a third subset of the one or more components of the subject web application system.

According to certain embodiments, the one or more components of the subject web application system define one or more channels via which the one or more components of the subject web application system can send or receive data, and the instructions, that when executed by the one or more processors, further cause the one or more processors to determine, based on the one or more channels, the combination parameter adherence status for the candidate component based on whether the candidate component can communicate via the defined one or more channels.

According to certain embodiments, the instructions that, when executed by the one or more processors, further cause the processors to generate a universal configuration hook comprising one or more error handling mechanisms, wherein the one or more error handling mechanisms are configured to manage exceptions encountered during data operations.

According to certain embodiments, the candidate component is part of a third-party system.

According to certain embodiments, the instructions that, when executed by the one or more processors, further cause the processors to generate, based on the one or more configurable adherence parameters, an adherence component library comprising a plurality of compliant components configured in accordance with the one or more configurable adherence parameters.

According to certain embodiments, the instructions that, when executed by the one or more processors, further cause the processors to determine, based on applying the one or more display interface compliance parameters of the one or more configurable adherence parameters to the one or more candidate component configuration elements, an interface adherence status for the candidate component.

According to certain embodiments, the candidate component is an interface component, and the one or more interface parameters comprise one or more rendering behavior parameters, one or more data handling capability parameters, or one or more interaction pattern parameters with which the interface component must comply.

According to certain embodiments, the instructions that, when executed by the one or more processors, further cause the processors to determine, based on the one or more configurable adherence parameters and one or more system compatibility statuses corresponding to one or more external components, an external system compatibility status corresponding to an external system comprising the one or more external components.

According to certain embodiments, the instructions, that when executed by the one or more processors, further cause the one or more processors to identify a set of candidate components wherein each candidate component of the set of candidate components (i) has a corresponding positive system compatibility status, and (ii) provides one or more component functions. The instructions that, when executed by the one or more processors, further cause the one or more processors to combine the set of candidate components into a single unified component, such that the single unified component enables a user to interact with the one or more component functions of each candidate component of the set of candidate components via a single interface.

According to certain embodiments, the instructions, that when executed by the one or more processors, further cause the one or more processors to add the candidate component to the subject web application system responsive to determining that the requested component is compatible according to the one or more adherence parameters.

According to certain embodiments, the instructions, that when executed by the one or more processors, further cause the one or more processors to reject the candidate component responsive to determining that the candidate component is not compatible according to at least one of the one or more adherence parameters.

According to certain embodiments, the instructions, that when executed by the one or more processors, further cause the one or more processors to define a user interface via which a user may provide input configuring the one or more configurable adherence parameters.

According to certain embodiments, the instructions, that when executed by the one or more processors, further cause the one or more processors to receive configuration input via the defined user interface.

According to certain embodiments, the instructions, that when executed by the one or more processors, further cause the one or more processors to generate one or more configurable universal data exchange formats, wherein the configurable universal data exchange formats are component data ingestion parameters for which one or more features can be altered while still retaining compliance with the one or more configurable adherence parameters.

According to certain embodiments, the instructions, that when executed by the one or more processors, further cause the one or more processors to define one or more data hooks configured to make data usable by one or more components of the subject web application system.

According to certain embodiments, the one or more components of the subject web application system include at least one of a data processor, data hook, API hook, UI component, universal component data ingestion hook, universal configuration hook, and a programming interface.

According to certain embodiments, the one or more components of the subject web application system are configured to execute one or more sequential data transformations on a data element to generate a transformed data element in a preferred data format, wherein the preferred data format is indicated by the one or more component data ingestion parameters.

According to certain embodiments, the instructions, that when executed by the one or more processors, further cause the one or more processors to generate one or more hooks to ensure standardized data retrieval and compatibility across APIs associated with the subject web application system.

According to certain embodiments, the instructions, that when executed by the one or more processors, further cause the one or more processors to determine, based on applying one or more combination parameters of the one or more configurable adherence parameters to the candidate component output data, a combination adherence status for the candidate component with respect to one or more components of the subject web application system.

According to certain embodiments, the one or more components of the subject web application system define one or more channels via which data can be sent to or received by the one or more components, and wherein the instructions causing the one or more processors to determine a combination adherence status for the candidate component comprise instructions to determine whether the candidate component can communicate via the defined one or more channels.

According to certain embodiments, the instructions, that when executed by the one or more processors, further cause the one or more processors to provide one or more error handling mechanisms integrated within a universal component data ingestion hook to identify and manage exceptions encountered during data retrieval or processing operations.

According to certain embodiments, the candidate component corresponds to one or more components of an existing third party system.

According to certain embodiments, the instructions, that when executed by the one or more processors, further cause the one or more processors to establish an adherence component library comprising a plurality of components configured in accordance with the one or more configurable adherence parameters.

According to certain embodiments, the instructions, that when executed by the one or more processors, further cause the one or more processors to determine, based on applying one or more interface parameters of the one or more configurable adherence parameters to the one or more candidate component configuration elements, an interface adherence status for the candidate component, wherein the one or more interface parameters indicate rendering behaviors, data handling capabilities, and interaction patterns required of an interface component.

According to certain embodiments, the instructions, that when executed by the one or more processors, further cause the one or more processors to analyze an external system for compatibility with the subject web application system according to an adherence engine configured to apply the one or more configurable adherence parameters.

One or more non-transitory computer-readable storage media are provided, the one or more non-transitory computer-readable storage media including instructions that, when executed by one or more processors, cause the one or more processors to receive, from a client device, a candidate component request comprising candidate component output data and one or more candidate component configuration elements associated with a candidate component. The instructions, that when executed by the one or more processors, further cause the one or more processors to determine, based on applying one or more component data ingestion parameters of one or more configurable adherence parameters to the candidate component output data, a component data ingestion protocol adherence status for the candidate component. The instructions, that when executed by the one or more processors, further cause the one or more processors to determine, based on applying one or more configuration element parameters of the one or more configurable adherence parameters to the one or more candidate component configuration elements, a configuration element protocol adherence status for the candidate component. The instructions, that when executed by the one or more processors, further cause the one or more processors to determine, based on one or more data outputs provided by one or more components of a subject web application system, one or more data transformation capabilities of the subject web application system. The instructions, that when executed by the one or more processors, further cause the one or more processors to determine, based on the component data ingestion protocol adherence status, the configuration element protocol adherence status, and the one or more data transformation capabilities of the subject web application system, a system compatibility status for the candidate component. The instructions, that when executed by the one or more processors, further cause the one or more processors to configure, based on the system compatibility status for the candidate component, the subject web application system.

A computer-implemented method comprises receiving, by one or more processors from a client device, a candidate component request comprising candidate component output data and one or more candidate component configuration elements associated with a candidate component. The computer-implemented method further comprises determining, by the one or more processors and based on applying one or more component data ingestion parameters of one or more configurable adherence parameters to the candidate component output data, a component data ingestion protocol adherence status for the candidate component. The computer-implemented method further comprises determining, by the one or more processors and based on applying one or more configuration element parameters of the one or more configurable adherence parameters to the one or more candidate component configuration elements, a configuration element protocol adherence status for the candidate component. The computer-implemented method further comprises determining, by the one or more processors and based on one or more data outputs provided by one or more components of a subject web application system, one or more data transformation capabilities of the subject web application system. The computer-implemented method further comprises determining, by the one or more processors and based on the component data ingestion protocol adherence status, the configuration element protocol adherence status, and the one or more data transformation capabilities of the subject web application system, a system compatibility status for the candidate component. The computer-implemented method further comprises configuring, by the one or more processors and based on the system compatibility status for the candidate component, the subject web application system.

Other embodiments include corresponding systems, methods, and computer programs, configured to perform the operations of the apparatus, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system that can benefit from technologies described herein.

FIG. 2 illustrates an example apparatus configured in accordance with at least one embodiment of the present disclosure.

FIG. 3 illustrates an example computing environment with which aspects of the present disclosure may be implemented.

FIG. 4 illustrates a data flow diagram in accordance with at least one embodiment of the present disclosure.

FIG. 5A illustrates an example component assembly mechanism in accordance with at least one embodiment of the present disclosure.

FIG. 5B illustrates an example data display widget in accordance with at least one embodiment of the present disclosure.

FIG. 6 illustrates a data flow diagram in accordance with at least one embodiment of the present disclosure.

FIG. 7 illustrates example operations for managing system component compliance in accordance with at least one embodiment of the present disclosure.

FIG. 8 illustrates example operations for component construction in accordance with at least one embodiment of the present disclosure.

FIG. 9 discloses an example computing environment with which aspects of the present disclosure may be implemented.

FIG. 10 illustrates an example machine learning framework for use with embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout.

### Overview

Embodiments of the present disclosure relate to web application development, and more specifically to enabling component compatibility within a data system. The techniques as described herein include an apparatus configured to receive a candidate component request, determine the candidate component's compliance with one or more configurable adherence parameters, and configuring a subject web application system according to the candidate component's determined compliance with the adherence parameters. In general, embodiments of the present disclosure provide techniques for ensuring ongoing component adherence to requirements of one or more adherence parameters, which can be configured according to system needs and/or user preferences.

Embodiments of the present disclosure enable flexible parameters facilitating consumers'ability to replace or modify pre-built components to align with specific needs. The provided flexibility increases efficiency in development of tools for data visualization and analysis, especially those tailored precisely to unique consumer requirements and preferences. Embodiments of the present disclosure enable amalgamation of functionality from multiple distinct components, such as directly combining a form widget and a chart widget, without requiring a consumer to write custom functionality to support such a use case. Example embodiments of the present disclosure may provide widgets operating inside a specific interface, thereby enabling drop in and replacement components to function without requiring modification. As such, the user is enabled to “mix and match” components of a larger widget to fit a specific use case. Embodiments of the present disclosure additionally enable a user to develop their own components to insert into the broader widget. For example, a user may develop their own custom drop-down menu component and insert it within one or more pre-built widgets without modifying the pre-built widgets'source code.

Embodiments of the present disclosure provide an adherence engine that defines the scope of a component and how it must interact with its corresponding components, such that the interface ensures compatibility between the subject component and its corresponding components. Such an interface also defines universal component data ingestion hooks, thereby enabling a consumer to define a custom hook for a new API, for example, such that the hook is designed to emit data in a pattern consistent with the interface. The hook may then be attached to the existing system, thereby enabling the system to have pre-built or custom components display the data fed by the universal component data ingestion hook without requiring any source code modification.

Embodiments of the present disclosure provide an interface defining a data processor and a data hook before feeding a component. A data processor enables data processing, transformation, and statistical inference capabilities with respect to subject data, and further allows the subject data to flow through the system. These additional layers of data processing enable a consumer to create complex data transformations without needing to modify any additional aspects of the system. Embodiments of the present disclosure allow arbitrary length processor chains, orders, and custom processing logic to handle processor interactions. The universal component data ingestion hook as provided is a final data format transformation which both supports a component and provides pagination and virtualization behavior, thereby enabling performance improvements.

Embodiments of the present disclosure provide a unified and scalable solution supporting seamless customization, extensibility, and modularization of system elements. Consumers can add support for a new API, create a processor to calculate variance, for example, enable pagination, create new UI widgets, etc., without requiring modifications to any other aspect of the system.

Embodiments of the present disclosure provide a system for modular data visualization and processing comprising a comprehensive suite of components including data processors, data hooks, API hooks, universal component data ingestion hooks, universal configuration hooks, UI components, and a component assembly mechanism facilitating seamless integration and customization of data analysis workflows. The API hooks of the system are designed to manage unique parameters, interface intricacies, and data transformation specifications specific to external data sources, ensuring standardized data retrieval and compatibility across diverse APIs.

Embodiments of the present disclosure provide a method for data transformation within the system, wherein data processors execute sequential data transformations, such as statistical analyses, data filtering, machine learning operations, and interpolation methods, ensuring standardized data outputs compatible with downstream components, wherein data processors can be chained, supporting integration from custom consumer-inserted processors, and consumer configured to specify order and precedence for said data processors.

Embodiments of the present disclosure provide a standardized interface specification governing the inputs, outputs, and behaviors of system components, including data processors, data hooks, UI components, and API hooks, ensuring seamless interoperability, compatibility, and extensibility across the system. The interface specification may facilitate the definition and implementation of custom data processors, data hooks, and UI components by adhering to interface guidelines, promoting component reusability, and supporting agile development practices.

Embodiments of the present disclosure provide a modular UI component framework within a system, enabling the combination and composition of smaller UI components into larger, functional units, thereby enhancing user interaction and data presentation capabilities, wherein UI components can be augmented with additional features such as aggregation summaries, interactive controls, and presentation styles including cards, modals, and drawers which seamlessly integrate. Each component defines its own endpoints which allow for automatic combination of compatible elements.

Embodiments of the present disclosure provide a method for building plug-and-play components using a component assembly mechanism, combining UI components, data processors, API hooks, data hooks, universal component data ingestion hooks, and universal configuration hooks into cohesive units that align with consumer needs, system requirements, and interface specifications, thereby streamlining development processes and ensuring component compatibility and consistency.

Embodiments of the present disclosure provide a method for building universal component data ingestion hooks which support robust error handling mechanisms integrated into system components. The error handling mechanism includes logging and reporting functionalities to track and analyze system errors, exceptions, and performance metrics, thereby facilitating troubleshooting, optimization, and continuous improvement of system functionalities.

Embodiments of the present disclosure provide an envelope format as used by the API hooks and the universal component data ingestion hooks for encapsulating metadata and contextual information within data payloads, enriching data representations, enhancing downstream processing capabilities, and supporting advanced data analytics and visualization functionalities within the system architecture.

Embodiments of the present disclosure provide a scalable and extensible system architecture that accommodates the integration of third-party components, plugins, and custom extensions, fostering collaboration, innovation, and the creation of diverse data visualization and processing workflows tailored to specific user requirements. The component interoperability and compatibility of the system architecture are maintained through adherence to standardized interfaces, data formats, and communication protocols, ensuring seamless integration and functionality across diverse system modules and external services.

Embodiments of the present disclosure provide a design for an interface enabling the passing of arbitrarily complex processing rules to a data processor, enabling consumer fine grain control over exact data processor operations.

As described, embodiments of the present disclosure provide improvements to the field of web application development and configuration among others. The techniques as described herein enable web application solutions which provide increased usability with respect to a plurality of components and/or widgets, while also reducing runtime errors by ensuring interoperability between components as implemented by a user. The modularity and universality provided by the various embodiments herein reduce errors and improve the performance of the computing devices and systems executing the software, as non-limiting examples, by producing better performing web applications in a shorter amount of time. Embodiments of the present disclosure provide further improvements by providing universal component data ingestion hooks enabling user customization of such data hooks while still ensuring adherence with one or more requirements of a subject web application system. Moreover, embodiments of the present disclosure provide a more intuitive, better performing development interface, whereby a user can create web applications via the graphical user interface elements described herein while the various embodiments described herein ensure code operability and optimal functionality.

### Example Terminology

As used herein, the terms “data,” “content,” “digital content,” “digital content object,” “information,” and similar terms may be used interchangeably to refer to data capable of being transmitted, received, and stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data entity,” “data object,” or “data set” may be used interchangeably to refer to data capable of being transmitted, received, and/or stored.

As used herein, the term “access” refers to the ability to receive, retrieve, view, make available, make use of, or the like, various data associated with embodiments described herein.

As used herein, the term “repository,” “database,” and/or the like, may be used to interchangeably refer to a computing location associated with a system where data is stored, accessed, modified, and otherwise maintained by the system. A repository may be used to store data in association with a data storage protocol and/or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the terms “web application system,” “subject web application system,” “subject system,”, and “subject web application configuration system” may be used to interchangeably refer to a software program stored on a remote server and accessed through a web browser. Web application systems as used herein may be designed to be interactive and allow users to send and receive data between the web browser and the server. In at least some embodiments, a web application system includes combinations of components configured to provide the functionality via which the user can interact with data displayed or otherwise presented by the web application system.

As used herein, the term “component” may be used to refer to a system unit that encapsulates a specific functionality. In at least some embodiments, a component corresponds to a modular unit of software that encapsulates a specific functionality. In at least some embodiments, a component corresponds to a hardware component, e.g., a physical part of a computing device. Generally, a component may refer to a processor, interface, widget, or other aspect of a subject web application system providing a specific functionality and/or enabling a user to perform a function or access a service. For example, with respect to a subject web application system, components may include data processors configured to provide customizable data transformations, data hooks configured to provide data for specific elements, widgets configured to enable a user to perform a function or access a service via an interface, interfaces enabling user interactions with functions and services of a web application system, and other system units which provide specific functionality via the web application system. With respect to embodiments of the present disclosure, the term component as used herein is used to refer to a unit of a web application system which enables data display either by displaying the data itself or by executing data transformation or manipulation operations to provide data to the components configured to display the data.

In at least some embodiments, the term “combined component” may be used to refer to a system unit which combines the functionalities of multiple components as described above into a single component; for example, a combined component may refer to a widget which both process subject data and displays the subject data via a user interface. With respect to the embodiments of the present disclosure, instances of the term “component” may refer to singular components or combined components.

As used herein, the term “component function interaction interface” may be used to refer to a system interface which combines the functionalities of multiple components as described above into a single component. In other words, a component function interaction interface may refer to a combined component comprising at least one interface component.

As used herein, the terms “candidate component” and “target component” may be used interchangeably to refer to a component as described above which is the target of adherence analysis with respect to a subject web application system. In at least some embodiments, a candidate component refers to a component which has issued a request to join the subject web application system. A candidate component may be a subject component of a request issued by another entity such as a client device, wherein the request from the client device requests that the candidate component be added to the subject web application system.

As used herein, the terms “candidate component request” and “target component request” may be used to refer to a request received by a subject web application system, or an adherence engine configured to configure, monitor, or otherwise manage the subject web application system, that indicates a request to add a corresponding candidate component to the subject web application system. The candidate component request may come from the candidate component itself, or from an additional entity such as a client device requesting that the candidate component be incorporated into the subject web application system.

As used herein, the term “component data ingestion” may be used to refer to a mechanism for sending or receiving data between components of a subject web application system. For example, a component data ingestion may correspond to the receiving of data as facilitated by an API hook. In general, the term component data ingestion as used herein refers to the sending of data from a component and the corresponding receipt of data by another component. A component data ingestion may be used to refer to a mechanism for receiving data which includes one or more requirements or parameters enabling receipt of said data. For example, a component data ingestion may require data be provided in one or more specified formats such that the receiving component can process or otherwise interact with the received data. Generally, a component data ingestion may refer to any instance of a subject component receiving data as part of a data transmission, data exchange, or other data delivery operation.

As used herein, the terms “adherence engine”, “adherence interface”, “programming interface,” and “data interface” may be used to refer to a programming interface for defining and otherwise implementing a set of rules, protocols, and methods for enabling seamless interaction between software components within a system. For example, an adherence engine may be configured to determine whether a subject component meets a set of parameters defined for adherence with respect to a subject web application system. An adherence engine may further include a mechanism by which a user can define one or more adherence parameters. In general, an adherence engine is an application through which components can be configured or otherwise verified according to a set of parameters such that the components comply with requirements of said set of parameters. By adhering to the defined adherence engine specifications and implementing required methods as indicated by the adherence engine, a new component is guaranteed to be made compatible and usable with existing elements. The adherence engine supports modularity, allowing components to be independently developed, tested, and integrated while ensuring consistent behavior and data interchange across the system.

In at least some embodiments, the adherence engine may be implemented as a schema layer defined between software layers of a system to enforce the interoperability of the various components of the software layers. For example, with respect to a multi-layer system comprising one or more software contracts negotiated by a JSON schema, the adherence engine may be implemented as an intermediate layer configured to enforce one or more parameters corresponding to component interoperability. In at least some embodiments, the adherence engine may be implemented at an infrastructure layer corresponding to the multi-layer system. The adherence engine may additionally be embodied at the data link layer. In at least some embodiments, the adherence engine includes a code base configured to indicate or otherwise display parameters as enforced by the adherence engine.

As used herein, the term “proper functioning” as used with respect to a component or a system may be used to refer to the subject entity's ability to complete one or more intended function without error. For example, with respect to a component such as a data processor configured to process data in a received format and provide an output dataset, “proper functioning” may describe the data processor's ability to appropriately process the received format and provide the desired output dataset. Similarly, “proper functioning” may refer to a component's ability to communicate with one or more additional components such that necessary data/information can be received. For example, with respect to a component such as a user interface widget that is configured to display data to a user, proper functioning may describe the user interface's ability to communicate with a data processor configured to provide the requisite data for display. In general, the term “proper functioning” refers to a subject entity's ability to execute operations and otherwise provide its intended function without error.

As used herein, the term “application programming interface” (or “API”) may be used to refer to a set of rules and protocols that allow different software applications to communicate and share data with one another. The term API may refer to software configured to enable the exchange of data between computer program products, components, repositories, and/or the like. For example, an API may be a standardized software intermediary associated with one or more hardware and/or software components configured to perform one or more functions of the API such as receiving and/or providing data (e.g., via requests and/or responses). An API may be associated with one or more standards, protocols, definitions, specifications, and/or the like, that define how communications facilitated by the API may be performed and/or how the API may be configured. An API may serve as a software intermediary enabling data transmissions between components. APIs can connect applications to other applications, applications to servers, and applications and servers to customers or consumers. In general, APIs define how software components interact.

As used herein, the term “Representational State Transfer” (or “REST”) is a software architectural style that defines how systems and applications communicate on the internet. REST may be used for designing networked applications and APIs which emphasize simplicity, scalability, and statelessness in communication between clients and servers over HTTP. REST defines a set of constraints for how the architecture of a distributed hypermedia system should interact. API hooks, when built according to the design as enforced by the adherence engine, are configured to comply with the constraints as defined by REST.

As used herein, the term “API hook” may be used to refer to a mechanism for extending, altering, or intercepting the functionality of an API at runtime. As such, API hooks facilitate seamless communication and data exchange between different software components, thereby enabling the customization or alteration of software behavior without the need to modify its source code. API hooks enable developers to ensure interoperability and compatibility between different applications, services, and systems. API hooks retrieve data from an API and transform the data into a standardized format according to predefined interface requirements, acting as an intermediary layer between the API and the system. Some API hooks may be configured to handle parameter options which are specific to a subject API. API hooks as used herein may leverage an envelope format for encapsulating metadata and contextual information within data payloads.

As used herein, the term “data hook” may be used to refer to a mechanism for preparing data for use by a specified component. For example, a data hook may be configured to add final transformations to make data usable by a specific component. In at least some embodiments, a data hook is configured to run code before or after certain interactions with a component. A data hook may function as a final data intermediary between raw data and final transformation for display, thereby allowing versatile functionalities such as pagination, translation, labeling, accessibility enhancements, and the like.

As used herein, the term “universal component data ingestion hook” may be used to refer to a customizable mechanism for preparing data for use by a specified component. A universal component data ingestion hook may include a data structure comprising one or more entries indicating one or more corresponding functions of the universal component data ingestion hook. An example universal component data ingestion hook may include a first entry corresponding to a function executed with respect to data of a first format and a second entry corresponding to a function executed with respect to data of a second format. In at least some embodiments, universal component data ingestion hooks are configured/defined with respect to a subject web application system, such that the use of the universal component data ingestion hooks with respect to the subject web application system ensures proper functioning of components of said system by ensuring that data is only provided in a format (or formats) which is processable or otherwise usable by the components. For example, if a subject web application system is ultimately configured to display data via a user interface widget, the universal component data ingestion hooks may be configured to transform or otherwise process subject data from various other components such that the subject data is ultimately provided to the user interface widget in a format that enables display of said data via the UI widget. Generally, universal component data ingestion hooks may be implemented to enforce adherence with respect to one or more parameters of, for example, an adherence engine.

In at least some embodiments, universal component data ingestion hooks include a combination of configurable entries and static entries. To that end, the configurable entries may correspond to entries which a user may adjust without impacting the functioning of the subject web application system. For example, the configurable entries may correspond to entries of a universal component data ingestion hook which a user may alter or otherwise edit without impacting the ability of other components of the subject web application system to carry out an intended function. Continuing the example from above, wherein a subject web application system is ultimately configured to display data via a user interface widget, the configurable entries of the universal component data ingestion hooks may include entries which do not correspond to data that is fed to the user interface widget, and therefore do not need to be in an explicit format as defined by the user interface widget. In the same example, the static entries may correspond to entries which a user may not adjust, as the entries correspond to a function whose parameters cannot be altered to ensure compliance with/adherence to one or more parameters of, for example, an adherence engine. Continuing the above example, wherein a subject web application is ultimately configured to display data via a user interface widget, the static entries of the universal component data ingestion hooks may include entries which correspond to data that is fed to the user interface widget, and therefore need to be in a specific format (or formats) such that the user interface widget can display the data as intended.

As used herein, the term “universal configuration hook” may be used to refer to a customizable mechanism for altering or intercepting the functionality of a component/widget at runtime. In at least some embodiments, a universal configuration hook may be used for altering or intercepting the functionality of a component/widget at runtime. A universal configuration hook may include a data structure comprising one or more entries indicating one or more corresponding functions of the universal configuration hook. An example universal configuration hook may include a first entry corresponding to configuration information associated with a component of a first type and a second entry corresponding to configuration information associated with a component of a second type. The configuration information may define one or more endpoints and/or channels corresponding to the subject (e.g., first or second) component type, wherein the defined endpoints and/or channels are mechanisms via which a target component can communicate or otherwise interface with the subject component. In at least some embodiments, universal configuration hooks are configured/defined with respect to a subject web application system, such that the use of the universal configuration hooks with respect to the subject web application system ensures proper functioning of components of said system by ensuring that target components which are added to the system are configured in a manner that enables them to communicate with components of the subject web application system. For example, if a subject web application system is ultimately configured to display data via a user interface widget, the universal component data ingestion hooks may be configured to transform or otherwise process subject data from various other components such that the subject data is ultimately provided to the user interface widget in a format that enables display of said data via the UI widget. Generally, universal component data ingestion hooks may be implemented to enforce adherence with respect to one or more parameters of, for example, an adherence engine.

In at least some embodiments, universal configuration hooks include a combination of configurable entries and static entries. To that end, the configurable entries may correspond to entries which a user may adjust without impacting the functioning of the subject web application system. For example, the configurable entries may correspond to entries of a universal configuration hook which a user may alter or otherwise edit without impacting the ability of other components of the subject web application system to carry out an intended function. Continuing the example from above, wherein a subject web application system is ultimately configured to display data via a user interface widget, the configurable entries of the universal configuration hooks may include entries which do not correspond to components which must communicate directly with the user interface widget, and therefore do not need to have an endpoint or channel via which the component can communicate or otherwise interact directly with the user interface widget. In the same example, the static entries may correspond to entries which a user may not adjust. Continuing the above example, wherein a subject web application is ultimately configured to display data via a user interface widget, the static entries of the universal component data ingestion hooks may include entries which correspond to components which must communicate directly with the user interface widget, and therefore need to have an endpoint or channel via which the communicate or otherwise interact directly with the user interface.

As used herein, the term “component data ingestion parameter” may be used to refer to a parameter defining a requirement of component data ingestions within a subject web application system. In at least some embodiments, component data ingestion parameters define one or more data formats which can be processed by at least one component of the subject web application system. For example, a component data ingestion parameter may define one or more features of an API hook, a universal component data ingestion hook, or a data hook configured to fetch or provide data to or from system components, such that the component data ingestion parameter indicates receivable/able to be processed via the API hook, the universal component data ingestion hook, or the data hook.

As used herein, the term “configuration element parameters” may be used to refer to one or more requirements corresponding to features or functions of a component such that a component's features must meet the one or more requirements to be added to a subject web application system. For example, a configuration parameter may indicate that a component must have at least one endpoint of a first format such that it can connect to one or more endpoints of one or more components in a subject web application system. In yet another example, a configuration parameter may indicate that a component must have at least one or more indicated security features to be added to a subject web application system.

As used herein, the term “data transformation capabilities” may be used to refer to a date entity describing data transformations achievable using one or more components of a subject web application system as currently configured. For example, a data transformation capability may indicate that a first selected format may be transformed into a second format or a third format using the existing components of the subject web application system. Notably, the data transformation capability indicates a data format which can be received by components of the subject web application system and can be either utilized in the current data format or can be transformed into a format usable by requisite components of the subject web application system.

As used herein, the term “component data ingestion parameter” may be used to refer to a parameter which defines one or more data formats required to enable proper functioning of the subject web application system. For example, a component data ingestion parameter may indicate a first data format corresponding to subject data which can be transmitted and otherwise utilized by components of the subject web application system. A component data ingestion parameter may be used to indicate a data format usable by all components of the subject web application system. Component data ingestion parameters may be used to indicate data formats usable by at least some components of the subject web application system.

As used herein, the term “interface parameters” or “display interface compliance parameters” may be used to refer to one or more parameters which define one or more data formats required to enable display via an interface of the subject web application system. For example, an interface parameter may indicate a first data format corresponding to subject data, wherein the first data format is capable of being processed or otherwise used by an interface component to display the requisite data.

As used herein, the term “configurable adherence parameters” may be used to refer to one or more parameters which define one or more requirements or conditions which a candidate component must meet to be added to a subject web application system. For example, the configurable adherence parameters may include a combination of interface parameters, component data ingestion parameters, and configuration element parameters which a candidate component must adhere to in order to be added to a subject web application system. In at least some embodiments, the configurable adherence parameters are parameters which a user may define, customize, or otherwise edit via a client device to enable user-defined compliance with respect to a subject web application system.

As used herein, the term “component data ingestion protocol adherence status” may be used to refer to a status or indicator which indicates whether or not a candidate component meets requirements as indicated by one or more component data ingestion parameters. A positive component data ingestion protocol adherence status, for example, may indicate that a candidate component satisfies a threshold number of the component data ingestion parameters, while a negative component data ingestion protocol adherence status indicates that a candidate component does not satisfy a threshold number of the component data ingestion parameters. In some embodiments, the threshold number of component data ingestion parameters corresponds to all of the implemented component data ingestion parameters, such that a failure to meet any one of the implemented component data ingestion parameters would yield a negative component data ingestion protocol adherence status.

As used herein, the term “configuration element protocol adherence status” may be used to refer to a status or indicator which indicates whether or not a candidate component meets requirements as indicated by one or more configuration element parameters. A positive configuration element protocol adherence status, for example, may indicate that a candidate component satisfies a threshold number of the configuration element parameters, while a negative configuration element protocol adherence status indicates that a candidate component fails to satisfy a threshold number of the configuration element parameters. In some embodiments, the threshold number of configuration element parameters corresponds to all of the implemented configuration element parameters, such that a failure to meet any one of the implemented component data ingestion parameters would yield a negative configuration element protocol adherence status.

As used herein, the term “system compatibility status” may be used to refer to a status or indicator which indicates whether or not a candidate component meets all requirements of the configurable adherence parameters as implemented by an adherence engine, and may be an aggregation of the configuration element protocol adherence status and the component data ingestion protocol adherence status as defined. In at least some embodiments, a positive system compatibility status may only be issued when both the configuration element protocol adherence status and the component data ingestion protocol adherence status are positive. A positive system compatibility status may ultimately lead to inclusion of the corresponding candidate component within the subject web application system.

As used herein, the terms “positive” or “positive status,” as used with respect to the system compatibility status, configuration element protocol adherence status, or the component data ingestion protocol adherence status, for example, may be used to refer to a status or indicator which indicates that a candidate component meets the requirements corresponding to the indicated status or parameters. In general, a “positive” indication indicates a component's compliance with a subject parameter or status.

As used herein, the terms “negative” or “negative status,” as used with respect to the system compatibility status, configuration element protocol adherence status, or the component data ingestion protocol adherence status, for example, may be used to refer to a status or indicator which indicates that a candidate component fails to meet the requirements corresponding to the indicated status or parameters. In general, a “negative” indication indicates a component's failure to comply with a subject parameter or status.

In at least some embodiments, the aforementioned parameters and statuses may be used to determine a component's adherence to, for example, a software architectural style such as REST which is utilized to define how systems and applications communicate on the internet. In other words, the parameters may be configured to align with the requirements as defined by REST such that compliance with the defined parameters would indicate compliance with systems or applications governed according to REST.

As used herein, the term “endpoint” may be used to refer to a mechanism by which a component can be operably connected to another component. For example, an endpoint may correspond to a channel via which data can be sent or received to the subject component.

As used herein, the term “adherence library” may be used to refer to a data repository configured to store information regarding a plurality of components and/or component data ingestion types which have been determined as adhering to, or otherwise satisfying, parameters as defined by an adherence engine.

As used herein, the term “React” may refer to an open source JavaScript library used for building user interfaces (UIs) in web applications. React utilizes a component-based architecture for constructing UIs. In at least some embodiments, the configurable adherence parameters may be configured to ensure compliance with components of a JavaScript library such as React, for example. In at least some embodiments, an adherence engine may be configured to manage a library of components compatible with components of a JavaScript library such as React. The adherence engine may be configured to support components which follow the React design. React uses a component signature to validate compliance.

As used herein, the term “user interface” (or “UI”, or “UI widget”) may be used to refer to interactive graphical elements or components used to display information or enable user interaction. Such components can include buttons, checkboxes, dropdown menus, sliders, etc., each serving specific purposes within an application. In general, a user interface refers to a component which provides a visual representation of data.

As used herein, the term “data processor” may be used to refer to a component for data transformation tasks. A data processor's functions span from performing statistical analyses (calculations of mean, median, etc., for example) to generating derivative datasets. Furthermore, a data processor may include advanced capabilities such as machine learning-driven interpolations and fundamental data manipulation operations including formatting adjustments, duplication, deduplication, and zero-padding. The data processor's core purpose is to process incoming data based on predefined algorithms or rules, thereby generating transformed datasets tailored for subsequent stages of analysis, visualization, or storage within a system.

As used herein, the terms “BuildWidget” and “BuildWidget function” may be used interchangeably to refer to a method for combining various elements, API hooks, universal component data ingestion hooks, universal configuration hooks, data processor(s), UI component(s), etc., and assembling them together into a single usable output component. The BuildWidget method generates an output suitable for direct user implementation as a plug-and-play drop-in component. In general, BuildWidget refers to a function used to combine disparate components, emitting a packaged plug and play component. “BuildWidget” may additionally be referred to as a “Factory Function,” for example.

As used herein, the term “candidate component output data” may be used to refer to output data as provided by a candidate component. Candidate component output data may refer generally to data formats as provided by a candidate component or to specific data as provided by the candidate component.

As used herein, the term “candidate component configuration elements” may be used to refer to elements of a candidate component which inform the component's ability to be configured to communicate with, or otherwise interface with, one or more additional components. In at least some embodiments, candidate component configuration elements correspond to endpoints of the candidate component and/or channels of the candidate component via which the candidate component can be connected to other components.

As used herein, the term “configuring”, such as is used with respect to configuring a subject web application system, may be used to refer to actions taken to connect, disconnect, or otherwise manage interoperability between components of the subject web application system and a target component. For example, configuring a target component and/or a subject web application system may include connecting an endpoint of the target component to an endpoint of the subject web application system. Configuring a target component with respect to a subject web application system may include denying the target component access to the subject web application system. In at least some embodiments, configuring a target component with respect to a subject web application system includes combining a target component with a selected component of the subject web application system. Configuring a target component may be executed according to a system compliance status as determined for the target component with respect to the subject web application system. In at least some embodiments, configuring a target component may include combining the target component with an additional component, such as via an endpoint of the target component and an endpoint of the additional component.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

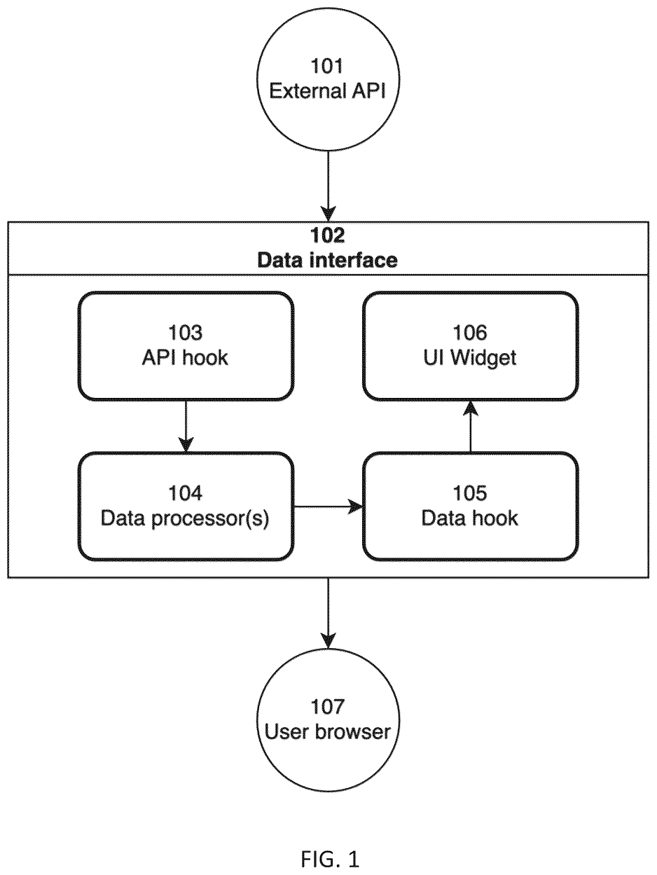

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps. An example system that can be used according to examples herein is described in FIG. 1.

FIG. 1 illustrates a data interface 102 configured to facilitate the flow of data from a compatible external API 101 to components connected to the data interface 102, and ultimately to a user browser 107 for rendering, according to example embodiments. With respect to the depicted embodiment, the system includes an external API 101, a data interface 102, and a user browser 107.

External API 101 can be a software intermediary enabling communication between an external application and components connected to data interface 102. Generally, external API 101 provides one or more channels via which data interface 102 can communicate (e.g., send and receive data) with one or more candidate components.

Data interface 102 can be an interface that defines a set of rules, protocols, and methods that enable seamless interaction and interoperability between different software components within a system. As depicted, the data interface 102 can include an API hook 103, one or more data processors 104, a data hook 105, and a UI widget 106. The data interface 102 plays a foundational role in defining the standardized inputs, outputs, and behaviors expected from system components such as data processors, data hooks, UI components, and API hooks. This structured interface specification serves as a blueprint that enables interoperability, modularization, and integration across diverse components within the system architecture. Data interface 102 outlines specific data formats, parameters, and functionalities that each component type must adhere to. For example, the interface specifies expected data input format for data processors and a corresponding output format that subsequent components should receive. This ensures that data transformations and manipulations performed by data processors align with downstream processing requirements. Additionally, UI components (such as UI widget 106) and data hooks (such as data hook 105) are governed by the interface guidelines, which dictate their rendering behaviors, data handling capabilities, and interaction patterns within the user interface. Each component, when defined in the appropriate way, provides its own definitions for how it can be combined and interacted with. By enforcing adherence to the specifications of the data interface 102, the system is able to implement a variety of data hooks, API hooks, widgets, etc., and combine any subset together and emit a working output.

API hook 103 can be a mechanism for extending, altering, or intercepting the functionality of external API 101, for example, at runtime. API hook 103 can be configured to retrieve data from external API 101 and transform the data into a standardized format as defined according to the data interface 102. API hook 103 can be configured to provide the transformed data to the one or more data processors 104. API hook 103 is designed to effectively manage intricacies and unique requirements of external API 101. Firstly, API hook 103 handles any special parameters mandated by external API 101, ensuring that all necessary parameters are included in data retrieval requests, thereby enabling the system to communicate effectively with external API 101 by retrieving the required data accurately and efficiently. The API hook 103 addresses any particulars or constraints specific to external API 101. For instance, API hook 103 may navigate restrictions such as limits on the number of rows returned in a single request, pagination requirements for large datasets, or rate-limiting policies imposed by the external API 101.

Further, API hook 103 can perform an initial aspect of data transformation, by transforming output from the external API 101 to a standard data format defined by the data interface 102 such that it can be used by any downstream components within the system architecture. This ensures consistency and compatibility across various data processing and visualization modules, facilitating seamless data integration and interoperability. API hook 103 may additionally provide error handling mechanisms to identify and manage exceptions encountered during data retrieval or processing operations, thereby enhancing system resilience, maintaining data integrity, and ensuring that unexpected issues are addressed promptly to minimize disruptions in data workflows. API hook 103 may additionally encapsulate relevant metadata and contextual information within a structured envelope format, which can be used by downstream components for certain operations.

In at least some embodiments, API hook 103 may correspond to a universal component data ingestion hook, as described above, such that API hook 103 comprises one or more configurable fields that may be customized by a user and one or more static fields which cannot be changed.

The one or more data processors 104 can each be a component configured for data transformation tasks. The one or more data processors 104 can be configured to process incoming data based on predefined algorithms or rules, thereby generating transformed datasets tailored for subsequent stages of analysis, visualization, or storage within our system. The one or more data processors 104 can be configured to transform the data from the API hook 103 into a format suitable for use by the UI widget 106, for example. The one or more data processors 104 can be configured to receive data outputted from the API hook, and may operate individually or as a chain of sequential processors, allowing for sequential execution of multiple processing steps to achieve complex transformations. Each of the one or more data processors 104 can be designed to output data in the same format it accepts, ensuring seamless integration and compatibility within processing workflows. The functionalities of the one or more data processors 104 encompass various operations such as statistical analyses (e.g. median calculation, mean calculation, etc.), data filtering (e.g. data removal, pruning), machine learning capabilities (e.g. time series prediction, classification), interpolation methods (e.g. zero padding), and more. Consumers also have the flexibility to build and integrate custom data processors tailored to their unique needs, enhancing the system's adaptability and extensibility. Consumers can configure the one or more data processors 104 with default or custom settings, defining the processing order, precedence rules, and any special options or parameters as needed. This configurability allows user to fine-tune data processing workflows.

Data hook 105 may be configured to prepare data specifically for use by the UI widget 106. In at least some embodiments, the data hook 105 is configured to run code prior to interactions with the UI widget 106 as a final data intermediary between raw data and final transformation for display via the UI widget 106, for example. Data hook 105 can enable versatile functionalities such as pagination, translation, labeling, accessibility enhancements, and the like. Data hook 105 can be configured to receive the data from the one or more data processors 104 and prepare the data for the UI widget 106. In some embodiments, data hook 105 adds final transformations to the data as required from a UI perspective to support functions such as pagination and virtualization. Data hook 105 can be created by the consumer in order to support a non-compliant widget that deviates from the data interface 102. Pre-built widgets follow a specification and as such require only one data hook that provides translation, accessibility labels, pagination, etc. However, in embodiments where consumers utilize large existing widget libraries that may not necessarily be able to accept the data format outputted by an existing data hook, the system allows a consumer to build a custom data hook that will transform the data into a data format required by a corresponding component, such as UI widget 106, allowing previously “incompatible” elements to be incorporated within the overall system.

In at least some embodiments, data hook 105 corresponds to a universal component data ingestion hook as described above, such that data hook 105 comprises one or more configurable fields that may be customized by a user and one or more static fields which cannot be changed.

UI widget 106 can include interactive graphical elements or components used to display data as provided by data hook 105. In some embodiments, UI widget 106 is configured to provide one or more interactive elements via which a user can interact with the displayed data. In general, UI widget 106 is configured to provide a visual representation of the data as provided by data hook 105. UI widget 106 can be configured to be used, rendered, or downloaded to a user or user device. UI widget 106 may be comprised of distinct compatible components which offer functionality beyond traditional static elements by offering the ability to combine and compose smaller components into larger, more functional units.

User browser 107 can be a software program or application that allows a user to access and view web pages. User browser 107 can be available via a user device, for example. In general, user browser 107 corresponds to a component via which the interactive graphical elements or components of the UI widget 106 are displayed to a user.

Though not depicted, the components of FIG. 1 may be configured to communicate via a network. In some embodiments, such as those wherein the components of data interface 102 are collocated within data interface 102, data interface 102 may be configured to communicate with user browser 107 and external API 101 via the network. In other embodiments, such as those where the various components of data interface 102 (API hook 103, data processor(s) 104, data hook 105, and UI widget 106) are located apart from one another, these components are configured to communicate with one another, and with external API 101, data interface 102, and user browser 107 as necessary, via the network. The network is a set of devices that facilitate communication from a sender to a destination, such as by implementing communication protocols. Example networks include local area networks, wide area networks, private networks such as an intranet, public networks such as the Internet, or any combination thereof. The network may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network may include a cellular telephone, an 802.11, 802.16, 802.20, or WiMax network. The network may utilize a variety of networking protocols now available or later developed including, but not limited to Transmission Control Protocol, Internet Protocol, etc.

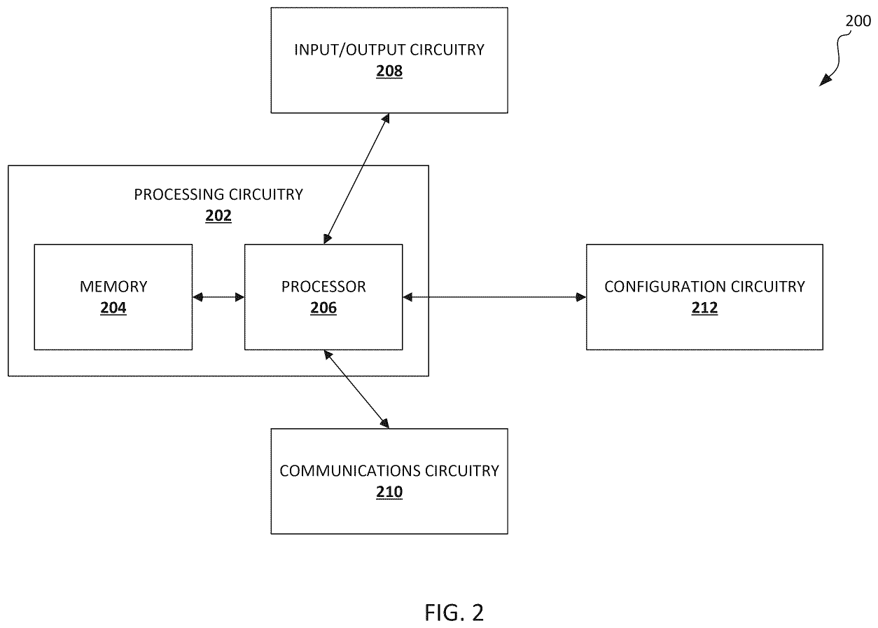

FIG. 2 illustrates a block diagram of an apparatus 200 in accordance with some example embodiments. In some embodiments, the apparatus 200 may include a processing circuitry 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry - in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208, and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a requesting entity, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some embodiments, the apparatus 200 may include a configuration circuitry 212 which may include hardware components, software components, and/or a combination thereof configured to, with the processing circuitry 202, input/output circuitry 208 and/or communications circuitry 210, perform one or more functions associated with the data interface 102 (as described above with reference to FIG. 1). For example, the configuration circuitry 212 may access, facilitate access, receive process, manipulate, provide, or otherwise use, or make available for use, data used by one or more other components of the apparatus 200 through, for example, the use of program code executed using a processor, such as the processor 206. In some embodiments, the configuration circuitry 212 may interact with the memory 204, which may store the aforementioned data. It should also be appreciated that, in some embodiments, the configuration circuitry 212 may include a separate processor, specially configured field programmable gate array (FPGA), or application specific interface circuit (ASIC) to provide or otherwise facilitate access to such data used by one or more other components of the apparatus 200. The configuration circuitry 212 may also provide for communication with other components of the apparatus, system and/or external systems via a network interface provided by the communications circuitry 210.

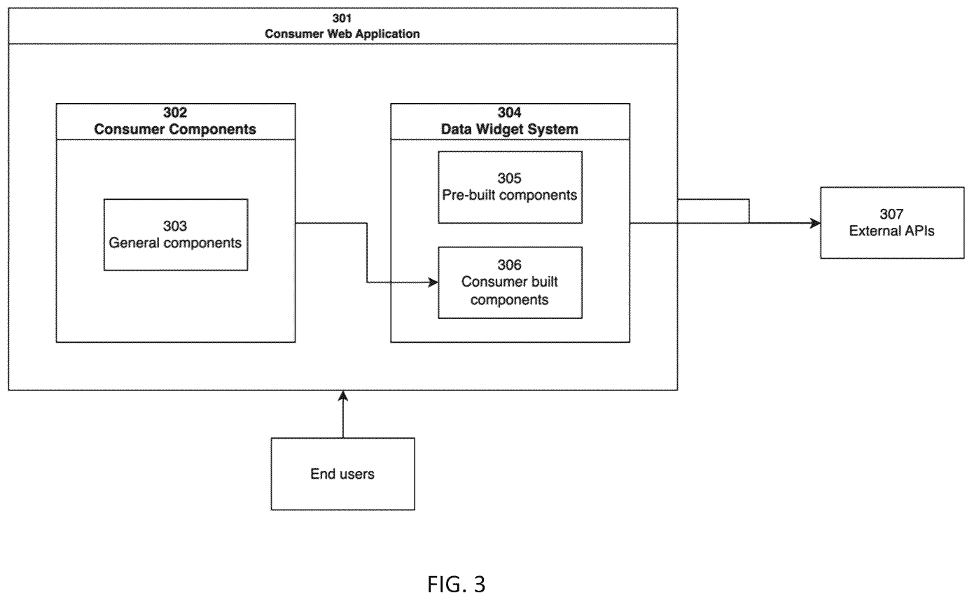

FIG. 3 illustrates an example consumer web application 301 in accordance with at least one embodiment of the present disclosure. As depicted, the consumer web application 301 includes consumer components 302 and a data widget system 304. As depicted, consumer web application may receive interaction from one or more end users. Consumer web application 301 may provide data output to one or more external APIs 307. FIG. 3 illustrates a combination of consumer components 302, pre-built components 305, and consumer-built components 306 customized/built using the data widget system 304 ultimately providing a consumer web application 301.

Consumer web application 301 may be a consumer-configured web application configured to provide data to one or more external APIs 307. As depicted, consumer web application 301 includes consumer components 302 and data widget system 304. In general, consumer web application 301 is configured to include components as provided or customized by a data widget system (such as pre-built components 305 and consumer-built components 306) based on general components 303 included in consumer components 302. As depicted, consumer components 302 include general components 303, wherein a general component corresponds to an existing component which has not been analyzed or otherwise altered by data widget system 304, such as a widget or an interface from an external system. Data widget system 304 includes one or more pre-built components 305 and one or more consumer-built components 306. In general, the general components 303 correspond to components which have been configured without the use of data widget system 304, the pre-built components 305 correspond to components which have previously been configured and confirmed to adhere to rules/guidelines implemented by the data widget system 304, and the consumer-built components 306 correspond to components which have been configured by the user in accordance with the rules/guidelines implemented by the data widget system 304.

In at least some embodiments, the data widget system 304 is configured to analyze the consumer components 302 to identify an intended (or provided) function of the consumer components 302. Once the data widget system 304 has identified said intended function, a widget library corresponding to data widget system 304 may be queried to identify one or more components which provide the intended function of the general components 303 of the consumer components 302. In at least some embodiments, data widget system 304 identifies pre-built components 305 which, either individually or in combination, provided the intended function of the general components 303. For example, if general components 303 transform data received in a first format to a second format, but the external APIs 307 require data in a third format differing from the second format, data widget system 304 may identify one or more pre-built components 305 from a widget library which can transform data from the second format to the third format, such that the component output will be usable by the external APIs 307.

In at least some embodiments, the data widget system 304 is configured to provide a blueprint according to which a user can build consumer-built components 306 such that the consumer-built components 306 will adhere to rules/guidelines which govern interoperability with respect to corresponding APIs, such as the external APIs 307. In general, the data widget system 304 is configured to ensure that the outputs of consumer web application 301 enable interoperability with target external components such as external APIs 307. External APIs 307 may include APIs configured to provide data in a format that is usable by one or more external components.

Consumer web application 301 may be managed by an adherence engine. Utilizing an adherence engine to manage compliance with the consumer web application 301 enables interoperability between the data widget system 304 and the general components 303, for example, without requiring user intervention or even user knowledge of the capabilities of the components. In general, components of consumer web application 301 are made readily interoperable by the adherence engine, thereby enabling simplicity of development and extending components'use with respect to the consumer web application 301.

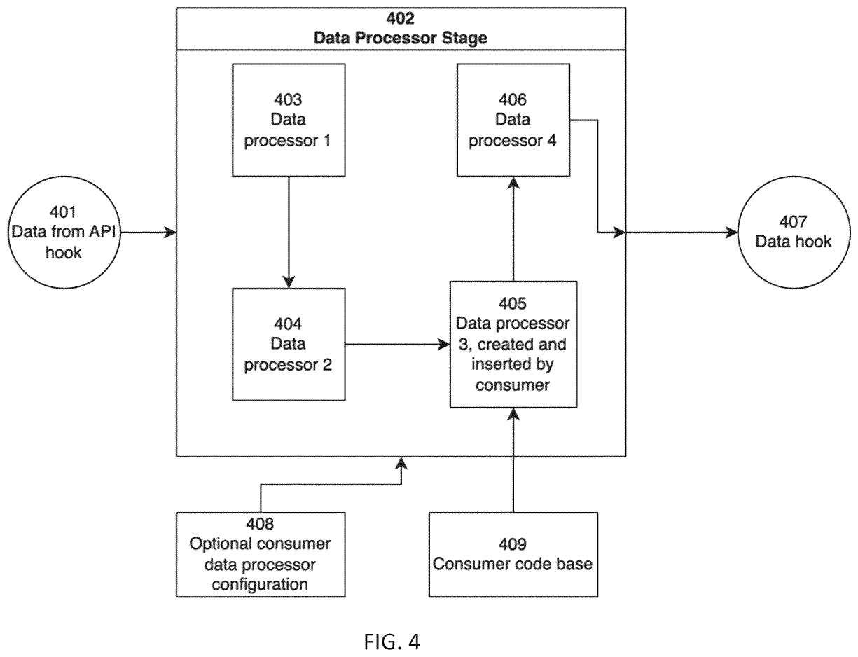

FIG. 4 illustrates a data flow diagram in accordance with at least one embodiment of the present disclosure. As depicted, a data processor stage 402 is configured to receive API hook data 401, a consumer data processor configuration 408, and a consumer code base 409. Data processor stage 402 is further configured to provide data to a data hook 407. In general, data processor stage is configured to transform API hook data 401 to a format usable by, or otherwise compatible with, data hook 407.

API hook data 401 can be data received via an API hook configured to retrieve data from a target API. As depicted, API hook data 401 can be received by data processor stage 402. In some embodiments, the API hook data 401 is received directly by a first data processor 403. In other embodiments, the API hook data 401 may be received by a component configured to manage data processor stage 402, and may ultimately be provided to first data processor 403 by said component. In at least some embodiments, the API hook data 401 corresponds to data received via a universal component data ingestion hook.

First data processor 403 may be configured to transform the API hook data 401 to a first dataset in a first format. Similarly, second data processor 404 may be configured to transform the first dataset in the first format to a second dataset in a second format, the third data processor 405 may be configured to transform the second dataset in the second format to a third dataset in a third format, and the fourth data processor 406 may be configured to transform the third dataset in the third format to a fourth dataset in a fourth format. As depicted, the third data processor 405 may correspond to a data processor created and inserted by a consumer according to a consumer code base 409, wherein consumer code base 409 is a complete body of source code for the third data processor 405, including any source files and configuration files needed to compile software associated with the third data processor 405 into machine code.

In general, the first data processor 403, the second data processor 404, the third data processor 405, and the fourth data processor 406 operate in a chain to provide extended data transformation capabilities beyond the transformations achievable using a single data processor. Various embodiments of the present disclosure provide a system that confers and enforces modularity among the data processors, such that the processors may be linked in various orders and in sequences of many data processors while ensuring that the web application is ultimately able to function and to prevent intermediate errors in communication between the data processors, such as for example, where a consumer chooses unexpected combinations of data processors. A consumer may insert their own data processor into the data processing chain, as is depicted with respect to the third data processor 405. A consumer may additionally create provide a data processor configuration 408 for modifying the data processing configuration. The data processor configuration 408 may indicate an order with which the data processors in the data processor stage 402 are implemented with respect to a data transformation. With respect to FIG. 4, an adherence engine may be implemented to ensure interoperability between the data processors.

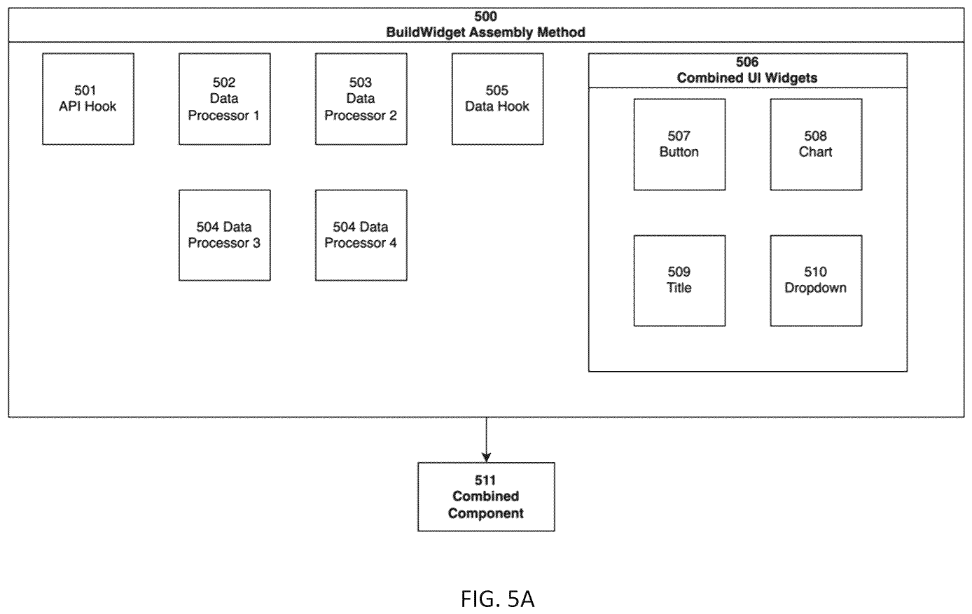

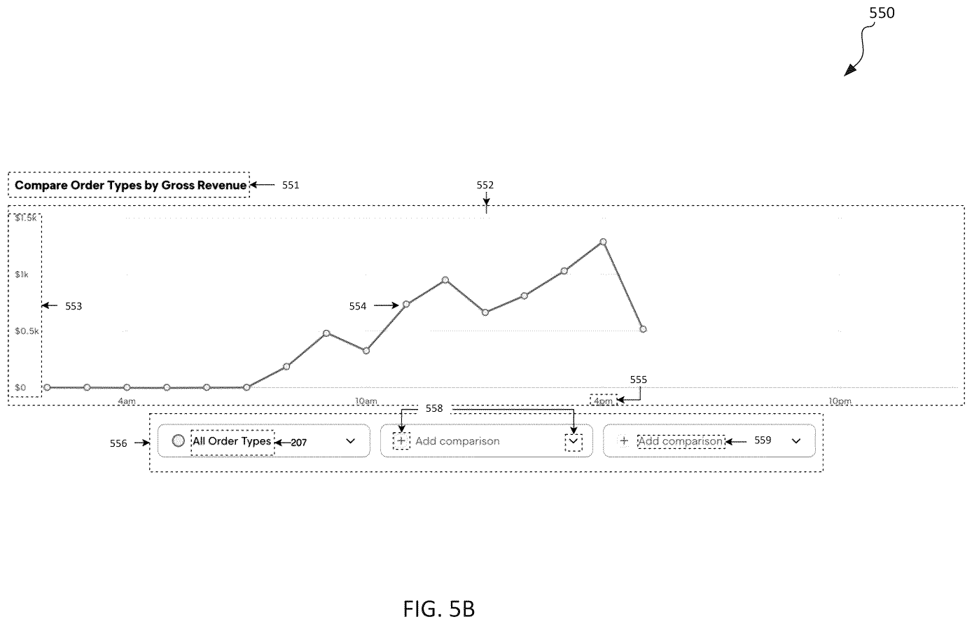

FIG. 5A illustrates a component assembly mechanism in accordance with at least one embodiment of the present disclosure. As depicted, the component assembly mechanism includes a BuildWidget assembly method 500 configured to combine a plurality of elements together to output a single usable component such as combined component 511. As depicted, the BuildWidget assembly method 500 is configured to combine an API hook 501, a first data processor 502, a second data processor 503, a third data processor 504, a fourth data processor 505, a data hook 506, combined UI widgets 512 including a button widget 507, a chart widget 508, a title widget 509, and a dropdown widget 510. The BuildWidget assembly method 500 aggregates the aforementioned elements into a single combined component 511. An example of a display of a single combined component 511 is depicted with respect to FIG. 5B.

In general, BuildWidget assembly method 500 serves as a final amalgamator within a system, functioning as a widget builder that combines an API hook, one or more data processors and corresponding optional data processor configuration(s), a data hook, and a widget, which itself may comprise multiple UI components. The BuildWidget assembly method 500 emits a cohesive and plug-and-play unit for consumers, such as combined component 511. The BuildWidget assembly method 500 validates a corresponding system interface, ensuring each element follows requirements as indicated by the interface. When combining components that follow the interface, each element can be replaced with a different element causing the created combined component 511 to emit a distinct and separate output.

The modular approach of the BuildWidget assembly method 500 allows consumers to create customized UI experiences by assembling components that cater to specific user interactions and data presentation requirements. For example, consider a scenario where a chart component needs to interact with user selections for displaying different data series. Consumers can specify a pre-built or custom built dropdown selection component to insert into the chart component, outputting a fully formed chart with functioning dropdown selector. The consumer can then choose a Title component to combine with, and then a card, modal or drawer to render the chart inside. As long as each component is built to describe its interface, another component, pre-built or consumer built, can be adapted to fit inside it, emitting a larger component. While most UI components focus on rendering and visualization tasks, they also possess the flexibility to interact with data hooks for specialized functionalities. For instance, a UI component can leverage a data hook to emit data into a download to the user's computer, for example in a CSV or JSON format.

BuildWidget assembly method 500 may be executed within, or according to, an adherence engine, such as has been described above. For example, the adherence engine may be utilized to ensure that each component added to a combined component (such as combined component 511) adheres to one or more parameters of the adherence engine. Similarly, the adherence engine may be utilized to ensure that the combined component itself (such as combined component 511) adheres to one or more parameters of the adherence engine. For example, BuildWidget assembly method 500 may be configured to provide combined component 511 according to one or more configuration element parameters, one or more component data ingestion parameters, and one or more interface parameters.

FIG. 5B illustrates an example data display widget in accordance with at least one embodiment of the present disclosure. As depicted, the overall data display widget 550 incorporates three end widgets: a title widget 551, a graph widget 552, and an action widget 556. Title widget 551 provides a title corresponding to the depicted components. Graph widget 552 provides a graphical display of a subject dataset. Action widget 556 provides a set of commands via which a user can manipulate or otherwise alter the data displayed via graph widget 552. As depicted, graph widget 552 and action widget 556 are made up of modular elements. Graph widget 552 includes y-axis element 553, trend line 554, and x-axis element 555. Y-axis element 553 indicates gross revenue on a scale from $0 to $1.5K. Trend line 554 indicates connected data points Action widget 556 includes an order type selection element 557, a first comparison element 558, and a second comparison element 559.

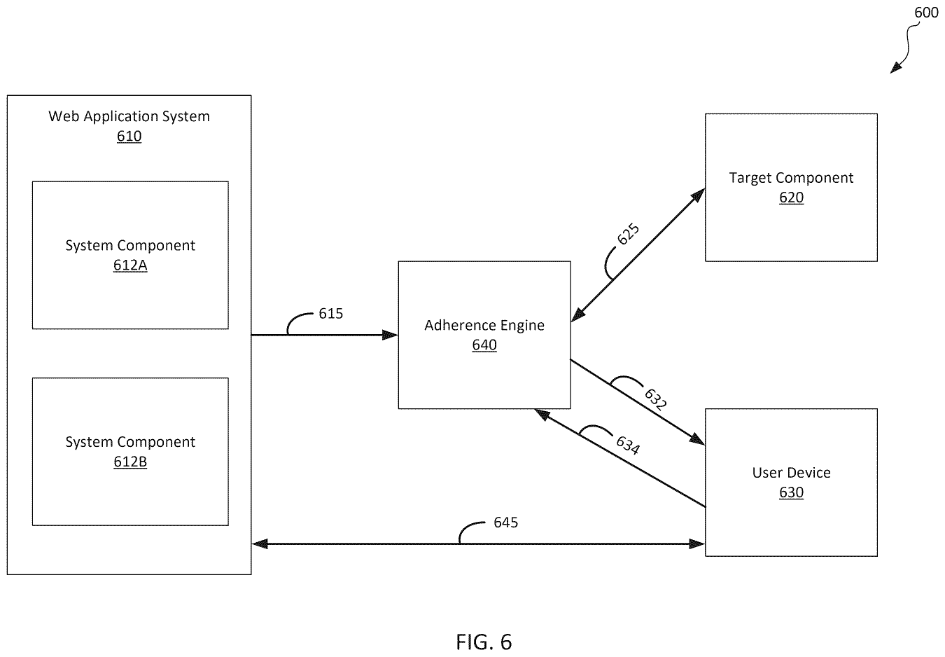

FIG. 6 illustrates a data flow diagram in accordance with at least one embodiment of the present disclosure. As depicted, an adherence system 600 includes a web application system 610, a target component 620, a user device 630, and an adherence engine 640. FIG. 6 additional depicts the flow of data between web application system 610, target component 620, user device 630, and adherence engine 640.

Web application system 610 may correspond to a web application system or a web application system managed by or according to adherence engine 640. As depicted, web application system 610 includes system components 612A, 612B (612). In at least some embodiments, system component 612A may be a different component type than system component 612B; for example, system component 612A may be a data processor, while system component 612B may be a user interface component. In general, system component 612A and system component 612B are representative of any number of existing system components corresponding to the web application system 610.

As depicted, web application system 610 is configured to provide data transformation capability information 615 to adherence engine 640. That is, web application system 610 may provide one or more data transformation capabilities corresponding to the system components 612 to adherence engine 640. In at least some embodiments, adherence engine 640 is configured to query web application system 610 regarding data transformation capability information 615.

Target component 620 may correspond to a component requesting access to, or being added to, the web application system 610. As depicted, target component 620 is configured to provide target component data 625 to adherence engine 640. In at least some embodiments, adherence engine 640 is configured to query target component 620 for target component data 625. Target component data 625 may include data output information corresponding to one or more data formats which may be provided by the system components 612. Target component data 625 may additionally include configuration information corresponding to the target component 620; for example, the target component data 625 may include an indication of one or more endpoints or channels via which target component 620 can communicate or otherwise interface with other components, such as system components 612.

User device 630 may include one or more user devices capable of interacting with adherence engine 640. For example, user device 630 may correspond to a device via which a user can provide one or more adherence parameters 634 corresponding to web application system 610. In general, user device 630 may include any device(s) via which a user can define parameters which govern component compliance with a web application system 610. For example, a user may use user device 630 to provide adherence parameters 634 including a combination of configuration element parameters, component data ingestion parameters, and interface parameters to be implemented with respect to web application system 610. As depicted, user device 630 may further be configured to receive a compatibility status 632 from adherence engine 640. The compatibility status 632 may include an indication of whether the target component complies with the adherence parameters 634.

Adherence engine 640 may be configured to determine whether target components (such as target component 620) comply with adherence parameters (such as adherence parameters 634) of a web application system (such as web application system 610). As such, adherence engine 640 is depicted to receive adherence parameters 634, either from user device 630 as depicted, or, with respect to other embodiments not depicted, from a web application system itself, such as web application system 610. Adherence engine 640 is additionally configured to receive target component data 625, and to determine whether the target component data 625 complies with the adherence parameters 634. For example, adherence engine 640 may be configured to compare configuration information for the target component 620 to configuration parameters of the adherence parameters 634. Adherence engine 640 may additionally be configured to compare the data output information of the target component 620 to component data ingestion parameters of the adherence parameters 634. Adherence engine 640 may be configured to determine a compatibility status 632 according to the target component's compliance with each of the adherence parameters 634. The compatibility status 632 may ultimately be utilized to determine whether target component 620 may be incorporated into, or otherwise granted access to, web application system 610.

### Example Methods

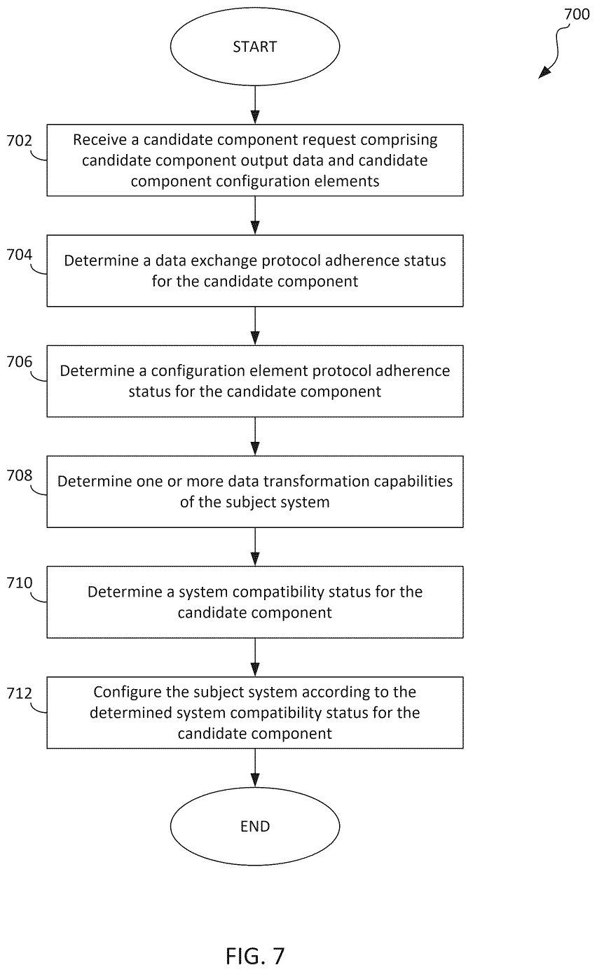

FIG. 7 illustrates an example method 700 for managing system component compliance in accordance with at least one embodiment of the present disclosure. As depicted, the example method 700 may include receiving (702) a candidate component request, determining (704) a component data ingestion protocol adherence status for the candidate component, determining (706) a configuration element protocol adherence status for the candidate component, determining (708) one or more data transformation capabilities of the subject web application system, determining (710) a system compatibility status for the candidate component, and configuring (712) a subject web application system according to the determined system compatibility status.

Receiving (702) a candidate component request may include receiving, from a client device, a candidate component request comprising candidate component output data and one or more candidate component configuration elements associated with a candidate component. The one or more candidate component configuration elements may comprise elements or features of the candidate component to be analyzed with respect to one or more configurable adherence parameters corresponding to a subject web application system.

Determining (704) a component data ingestion protocol adherence status for the candidate component may include analyzing output data as provided by the candidate component according to one or more component data ingestion parameters of one or more configurable adherence parameters. The component data ingestion protocol adherence status may indicate a pass/fail status, such that the status is “Passed” or any positive indication in the event that the candidate component's output data meets all requirements of the component data ingestion parameters, or the status is “Failed” or any other negative indication in the event that the candidate component's output data fails to meet one or more requirements of the component data ingestion parameters. In at least some embodiments, the component data ingestion protocol adherence status may further indicate which component data ingestion parameters are satisfied or passed, and which are failed.

Determining (706) a configuration element protocol adherence status for the candidate component may include analyzing the one or more candidate component configuration elements according to one or more configuration element parameters of the one or more configurable adherence parameters. The configuration element protocol adherence status may indicate a pass/fail status, such that the status is “Passed” or any positive indication in the event that the candidate component's configuration elements meet all requirements of the configuration element parameters, or the status is “Failed” or any other negative indication in the event that the candidate component's output data fails to meet one or more requirements of the configuration element parameters. In at least some embodiments, the configuration element protocol adherence status may further indicate which configuration element parameters are satisfied or passed, and which are failed. The configuration element protocol adherence status for the candidate component may include an indication that the candidate component's endpoints/available channels are compatible with the endpoints/available channels of components of the subject web application system.

Determining (708) one or more data transformation capabilities of the subject web application system may include identifying input data formats and output data formats with respect to one or more components of the subject web application system to identify a set of input data formats that can be transformed to a corresponding set of output data formats by the components of the subject web application system. In at least some embodiments, determining (708) one or more transformation capabilities of the subject web application system may include determining whether the subject web application system comprises a component (or a combination of components) which can transform non-compliant data from the candidate component into a usable format that adheres to the component data ingestion parameters. In the event that the subject web application system does indeed include components capable of transforming such non-compliant data, the method 700 may additionally include updating the component data ingestion protocol adherence status from “passed” to “failed.”

Determining (710) a system compatibility status for the candidate component may include determining whether a candidate component is compatible with the subject web application system based, at least in part, on the component data ingestion protocol adherence status, the configuration element protocol adherence status, and the one or more data transformation capabilities of the subject web application system. In at least some embodiments, the system compatibility status may indicate a “Passed” (or otherwise positive) status if the candidate component has a positive status with respect to both the component data ingestion protocol adherence status and the configuration element protocol adherence status. In at least some embodiments, the system compatibility status may indicate a “Failed” (or otherwise negative) status if the candidate component has a negative status with respect to either of the component data ingestion protocol adherence status and the configuration element protocol adherence status. In general, the system compatibility status offers an indication of whether a component candidate can be added to a system without disrupting interoperability of the system components as a whole.

Configuring (712) the subject web application system according to the determined system compatibility status for the candidate component may include adding the candidate component to the subject web application system responsive to determining the system compatibility status for the candidate component is positive. Adding the candidate component to the system may include configuring one or more endpoints or channels such that the candidate component can communicate with the other components of the subject system. Configuring (712) the subject web application system according to the determined system compatibility status for the candidate component may include rejecting the candidate component responsive to determining the system compatibility status for the candidate component is negative. Rejecting the candidate component may simply include taking no action to add the component to the system. In at least some embodiments, rejecting the candidate component includes blocking the component's access to the subject web application system.

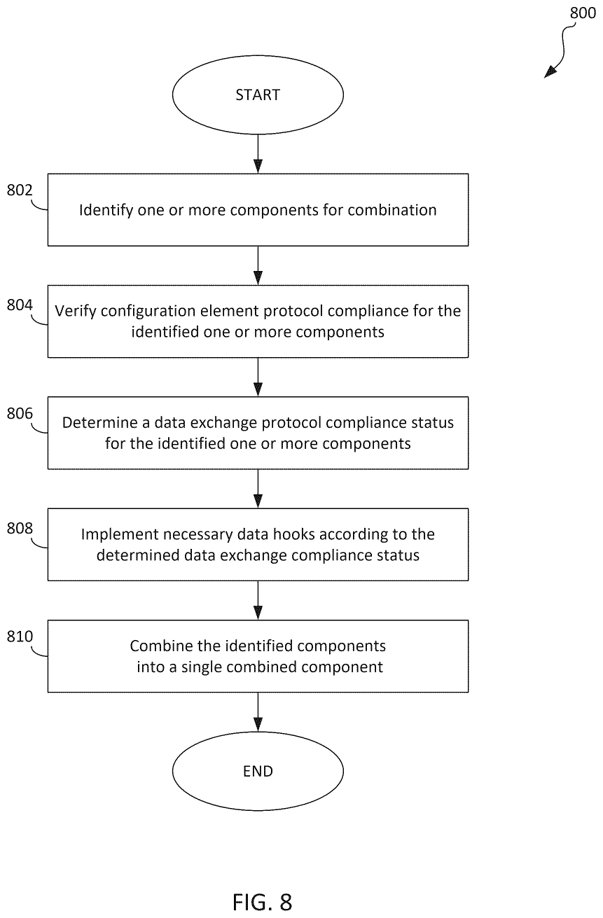

FIG. 8 illustrates an example method 800 for building a component in accordance with at least one embodiment of the present disclosure. As depicted, the method 800 includes identifying (802) components for combination, verifying (804) configuration element protocol compliance for the identified components, determining (806) a component data ingestion protocol compliance status for the identified components, implementing (808) necessary data hooks according to the determined data exchange compliance status for the identified components, and combining (810) the identified components into a single combined component.

Identifying (802) components for combination may include receiving a request to combine one or more components. In at least some embodiments, the received request may explicitly indicate each of the one or more components to be combined. In some embodiments, the received request may indicate some of the one or more components to be combined, along with an intended function or description of additional unknown components to be included in the combination. In yet other embodiments, the received request may not indicate any of other one or more components to be combined explicitly, but may instead include only desired functions/descriptions of components to be combined. In embodiments wherein the desired components are not explicitly indicated, method 800 may additionally include querying a component library to identify components providing the indicated desired functions or otherwise meeting the provided descriptions.

Verifying (804) configuration element protocol compliance for the identified components may include analyzing one or more component configuration elements of the identified components according to one or more configuration element parameters. A configuration element protocol adherence status may be determined indicating a pass/fail status, such that the status is “Passed” or any positive indication in the event that the identified components'configuration elements meets all requirements of the configuration element parameters, or the status is “Failed” or any other negative indication in the event that the identified components'output data fails to meet one or more requirements of the configuration element parameters. In at least some embodiments, the configuration element protocol adherence status may further indicate which configuration element parameters are satisfied or passed, and which are failed.

Determining (806) a component data ingestion protocol compliance status for the identified components may include analyzing output data as provided by the identified components according to one or more component data ingestion parameters of one or more configurable adherence parameters. The component data ingestion protocol adherence status may indicate a pass/fail status, such that the status is “Passed” or any positive indication in the event that the identified components'output data meets all requirements of the component data ingestion parameters, or the status is “Failed” or any other negative indication in the event that the candidate components' output data fails to meet one or more requirements of the component data ingestion parameters. In at least some embodiments, the component data ingestion protocol adherence status may further indicate which component data ingestion parameters are satisfied or passed, and which are failed.

Implementing (808) necessary data hooks according to the determined data exchange compliance status for the identified components may include identifying any component data ingestion parameters which are failed, and identifying an output format corresponding to the failed component data ingestion parameter(s). Implementing (808) necessary data hooks may include identifying one or more data hooks capable of transforming the identified output data format corresponding to the failed component data ingestion parameter(s) into a data format which satisfies the failed component data ingestion parameter(s). In the event that such a data hook is indeed available, the method 800 further includes adding the data hook to the components for combination. In the event that such a data hook is not available, the method 800 may additionally include providing an error message or other indication that the components cannot be combined in a satisfactory manner compliant with the subject web application system. In at least some embodiments, implementing (808) necessary data hooks includes implementing one or more universal component data ingestion hooks, as configured by a user, to transform data from the identified output data format into a data format which satisfies the failed component data ingestion parameter.

Combining (810) the identified components into a single combined component may include combining the features of the identified components into a single combined component or widget, such that an end user can access the functionality of each of the identified components via the single combined component. The single combined component may be provided to an end user via a user interface of a user device, for example.

### Example Computing Environment

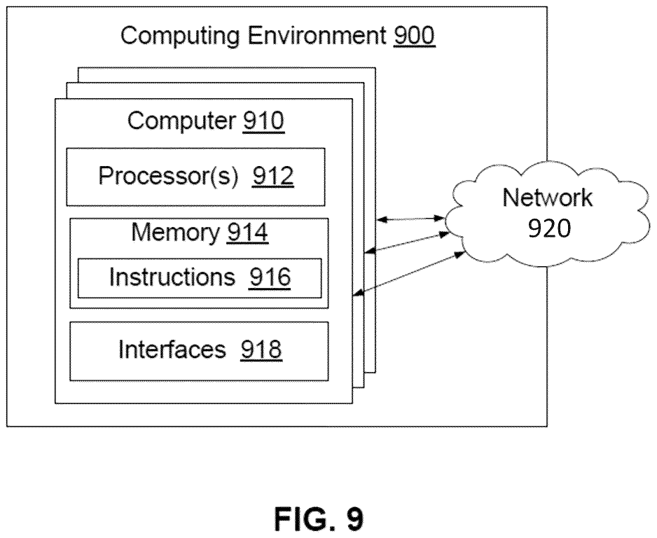

FIG. 9 discloses a computing environment 900 in which aspects of the present disclosure may be implemented. A computing environment 900 is a set of one or more virtual or physical computers 910 that individually or in cooperation achieve tasks, such as implementing one or more aspects described herein. The computers 910 have components that cooperate to cause output based on input. Example computers 910 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 900 includes at least one physical computer.

The computing environment 900 may specifically be used to implement one or more aspects described herein. In some examples, one or more of the computers 910 may be implemented as a user device, such as mobile device and others of the computers 910 may be used to implement aspects of a machine learning framework useable to train and deploy models exposed to the mobile device or provide other functionality, such as through exposed application programming interfaces.

The computing environment 900 can be arranged in any of a variety of ways. The computers 910 can be local to or remote from other computers 910 of the computing environment 900. The computing environment 900 can include computers 910 arranged according to client-server models, peer-to-peer models, edge computing models, other models, or combinations thereof.

In many examples, the computers 910 are communicatively coupled with devices internal or external to the computing environment 900 via a network 920.

In some implementations, computers 910 can be general-purpose computing devices (e.g., consumer computing devices). In some instances, via hardware or software configuration, computers 910 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 910 include one or more processors 912, memory 914, and one or more interfaces 918. Such components can be virtual, physical, or combinations thereof.

The one or more processors 912 are components that execute instructions, such as instructions that obtain data, process the data, and provide output based on the processing. The one or more processors 912 often obtain instructions and data stored in the memory 914. The one or more processors 912 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 912 include at least one physical processor implemented as an electrical circuit. Example providers of processors 912 include INTEL, AMD, QUALCOMM, TEXAS INSTRUMENTS, and APPLE.

The memory 914 is a collection of components configured to store instructions 916 and data for later retrieval and use. The instructions 916 can, when executed by the one or more processors 912, cause execution of one or more operations that implement aspects described herein. In many examples, the memory 914 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 914 can store information encoded in transient signals.

The one or more interfaces 918 are components that facilitate receiving input from and providing output to something external to the computer 910, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The one or more interfaces 918, such as a communication interface, can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 918 can facilitate connection of the computing environment 900 to a network 920.

The network 920 is a set of devices that facilitate communication from a sender to a destination, such as by implementing communication protocols. Example networks include local area networks, wide area networks, private networks such as an intranet, public networks such as the Internet, or any combination thereof. The network may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network may include a cellular telephone, an 802.11, 802.16, 802.20, or WiMax network. The network may utilize a variety of networking protocols now available or later developed including, but not limited to Transmission Control Protocol, Internet Protocol, etc.

The computers 910 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Example Machine Learning Framework

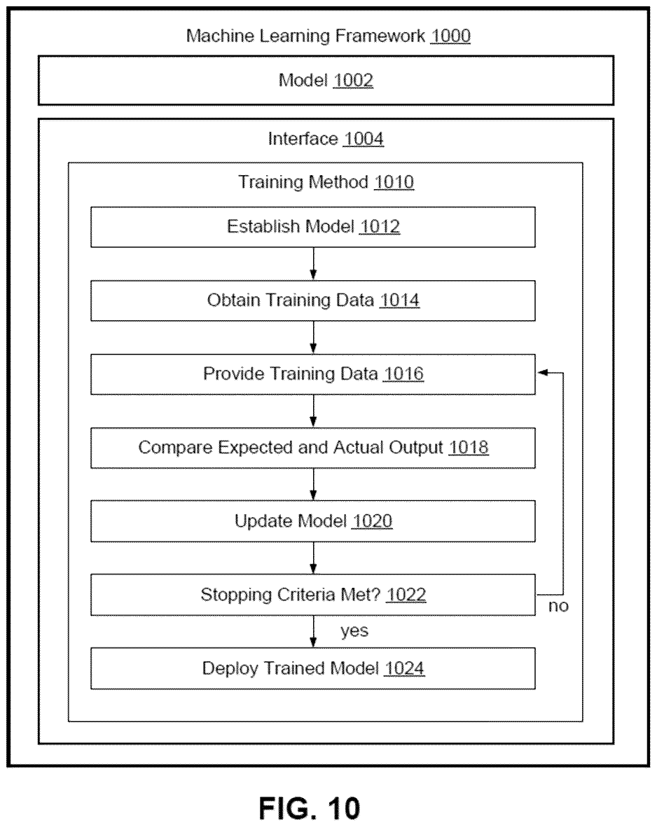

FIG. 10 illustrates an example machine learning framework 1000 that techniques described herein may benefit from or improve on. A machine learning framework 1000 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 1000 or components thereof are often built or refined from existing frameworks, such as TENSORFLOW by GOOGLE, INC. or PYTORCH by the PYTORCH community. The machine learning frameworks 1000 may correspond to techniques as leveraged by the various data processors as described herein for various data processing functions.

The machine learning framework 1000 can include one or more models 1002 that are the structured representation of learning and an interface 1004 that supports use of the model 1002. The model 1002 may include can take any of a variety of forms. In many examples, the model 1002 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 1002 can include a representation of memory (e.g., providing long short-term memory functionality). Where the set includes more than one model 1002, the models 1002 can be linked, cooperate, or compete to provide output.

The interface 1004 can include software procedures (e.g., defined in a library) that facilitate the use of the model 1002, such as by providing a way to establish and interact with the model 1002. For instance, the software procedures can include software for receiving input, preparing input for use (e.g., by performing vector embedding, such as using Word2Vec, BERT, or another technique), processing the input with the model 1002, providing output, training the model 1002, performing inference with the model 1002, fine tuning the model 1002, other procedures, or combinations thereof.

In an example implementation, interface 1004 can be used to facilitate a training method 1010. The training method 1010 may therefore include or be used to implement operation 224 of FIG. 2. The training method 1010 may include operation 1012, which includes establishing a model 1002, such as initializing a model 1002. The establishing can include setting up the model 1002 for further use (e.g., by training or fine tuning). The model 1002 can be initialized with values. In examples, the model 1002 can be pretrained.

Operation 1014 can follow operation 1012. Operation 1014 includes obtaining training data; in many examples, the training data includes pairs of input (e.g., training sequence data objects and respective contextual data objects) and desired output (e.g., labels) given the input. In supervised or semi-supervised training, the data can be prelabeled, such as by human or automated labelers. In unsupervised learning the training data can be unlabeled.

Many examples herein are related to supervised prediction of disruptions to pinpoint the weights or importance of events. But certain embodiments may operate without explicit labels but with implicit labels computed based on other data. Thus data need not be explicitly labeled. But it can be beneficial to use an input labeler to infer labels and to train a supervised model.

The training data can include validation data used to validate the trained model 1002. Operation 1016 can follow operation 1014. Operation 1016 includes providing a portion of the training data to the model 1002. This can include providing the training data in a format usable by the model 1002. The machine learning framework 1000 (e.g., via the interface 1004) can cause the model 1002 to produce an output based on the input.

Operation 1018 can follow operation 1016. Operation 1018 includes comparing the expected output with the actual output. In an example, this can include applying a loss function to determine the difference between expected and actual data. This value can be used to determine how training is progressing. Operation 1020 can follow operation 1018. Operation 1020 includes updating the model 1002 based on the result of the comparison. This can take any of a variety of forms depending on the nature of the model 1002. Where the model 1002 includes weights, the weights can be modified to increase the likelihood that the model 1002 will produce correct output given an input. Depending on the model 1002, backpropagation or other techniques can be used to update the model 1002.

Operation 1022 can follow operation 1020. Operation 1022 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 1014. If the stopping criterion has been satisfied, the flow can move to operation 1022.

Operation 1024 includes deploying the trained model 1002 for use in production, such as providing the trained model 1002 with real-world input data and produce output data used in a real-world process. The model 1002 can be stored in memory 914 of at least one computer 910 or distributed across memories of two or more such computers 910 for production of output data.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context—including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks.

By sharing model parameters and applying transfer learning techniques across customers, example embodiments can leverage the knowledge gained from one customer's transactional data to improve the forecasting for another. This transfer of learning allows the model to generalize across customers and capture common patterns and trends, resulting in more accurate predictions.

### Non-limiting Example Embodiments

Consider a dynamic company that offers a customer-centric portal for comprehensive sales reports. This portal provides their customers with easy access to detailed, interactive sales reports on both web and mobile platforms. The reports need to include visually engaging elements like pie charts, line charts, tables, and area charts to quickly convey key insights.

With respect to the present example, embodiments of the present disclosure provide a system comprising a universal component data ingestion hook that is configured to fetch raw sales data from the company's customer relationship management (CRM) system. The universal component data ingestion hook is configured to handle the specific API parameters and authentication required by the CRM system. The provided system may further comprise one or more data processors employed to clean, filter, and aggregate the sales data. One processor might calculate monthly sales totals, for example, another might segment sales by product category, and yet another might calculate year-over-year growth. The provided system may further comprise separate universal component data ingestion hooks created for each type of visualization (pie chart, line chart, etc.). These universal component data ingestion hooks receive the processed data and transform it into the format needed for one or more included UI widget(s). Each included UI widget may be a pre-built or custom UI widget corresponding to one of the visualization types. The pie chart widget, for example, might include options for color customization and interactive labeling via the provided UI. The provided system leverages the BuildWidget method to combine the universal component data ingestion hooks, data processors, and UI widgets into a single, cohesive widget. The resulting widget is integrated into the company's web portal and mobile app, thereby providing the sales team, for example, with a consistent and interactive reporting experience across platforms.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The various embodiments described herein are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims. Although specific terms are employed herein, they are used in a generic and descriptive sense only and not for purposes of limitation.

1. An apparatus comprising one or more processors and at least one non-transitory memory comprising instructions that, when executed by the one or more processors, cause the one or more processors to:
receive, from a client device, a candidate component request comprising candidate component output data and one or more candidate component configuration elements associated with a candidate component;
determine, based on applying one or more component data ingestion parameters of one or more configurable adherence parameters to the candidate component output data, a component data ingestion protocol adherence status for the candidate component;
determine, based on applying one or more configuration element parameters of the one or more configurable adherence parameters to the one or more candidate component configuration elements, a configuration element protocol adherence status for the candidate component;
determine, based on one or more data outputs provided by one or more components of a subject web application system, one or more data transformation capabilities of the subject web application system;
determine, based on the component data ingestion protocol adherence status, the configuration element protocol adherence status, and the one or more data transformation capabilities of the subject web application system, a system compatibility status for the candidate component; and
configure, based on the system compatibility status for the candidate component, the subject web application system.

2. The apparatus of claim 1, wherein the at least one non-transitory memory further comprises instructions that, when executed by the one or more processors, cause the one or more processors to:
receive, from a client device, the one or more configurable adherence parameters representing a plurality of conditions which a target component must meet to ensure compatibility with a first subset of the one or more components of the subject web application system.

3. The apparatus of claim 1, wherein the one or more components of the subject web application system are configured to execute one or more sequential data transformations to generate a transformed data element in a preferred data format, wherein the preferred data format is indicated by the one or more component data ingestion parameters.

4. The apparatus of claim 1, wherein the at least one non-transitory memory further comprises instructions that, when executed by the one or more processors, cause the one or more processors to:
identify a candidate components set comprising a plurality of candidate components, wherein each candidate component of the candidate components set (i) is associated with a system compatibility status that is positive, and (ii) provides one or more component functions; and
combine the candidate components set into a single unified component that enables a user to interact with the one or more component functions of each candidate component of the candidate components set via a component function interaction interface.

5. The apparatus of claim 1, wherein the at least one non-transitory memory further comprises instructions that, when executed by the one or more processors, cause the one or more processors to:
responsive to determining that one or more of the component data ingestion protocol adherence status, the configuration element protocol adherence status, or the system compatibility status is negative, reject the candidate component.

6. The apparatus of claim 1, wherein the at least one non-transitory memory further comprises instructions that, when executed by the one or more processors, cause the one or more processors to:
generate, based on the one or more configurable adherence parameters, a configurable adherence engine configured to render a user input interface via which a user can configure the one or more configurable adherence parameters.

7. The apparatus of claim 1, wherein the at least one non-transitory memory further comprises instructions that, when executed by the one or more processors, cause the one or more processors to:
generate, based on the one or more component data ingestion parameters, one or more configurable universal data exchange formats, wherein the one or more configurable universal data exchange formats comprise one or more entries which can be altered while still maintaining compliance with the one or more configurable adherence parameters.

8. The apparatus of claim 1, wherein the at least one non-transitory memory further comprises instructions that, when executed by the one or more processors, cause the one or more processors to:
define, based on the one or more configurable adherence parameters, one or more universal component data ingestion hooks configured to provide data in a format that is compatible with a second subset of the one or more components of the subject web application system.

9. The apparatus of claim 1, wherein the at least one non-transitory memory further comprises instructions that, when executed by the one or more processors, cause the one or more processors to:
responsive to determining that the system compatibility status is positive, add the candidate component to the subject web application system.

10. The apparatus of claim 1, wherein the at least one non-transitory memory further comprises instructions that, when executed by the one or more processors, cause the one or more processors to:
generate one or more universal component data ingestion hooks to ensure standardized data retrieval and compatibility across APIs associated with the subject web application system.

11. The apparatus of claim 1, wherein the one or more configurable adherence parameters comprise one or more combination parameters, and wherein the at least one non-transitory memory further comprises instructions that, when executed by the one or more processors, cause the one or more processors to:
determine, based on applying the one or more combination parameters to the candidate component output data, a combination parameter adherence status for the candidate component with respect to a third subset of the one or more components of the subject web application system.

12. The apparatus of claim 11, wherein the one or more components of the subject web application system define one or more channels via which the one or more components of the subject web application system can send or receive data, and wherein the at least one non-transitory memory further comprises instructions that, when executed by the one or more processors, cause the one or more processors to:
determine, based on the one or more channels, the combination parameter adherence status for the candidate component based on whether the candidate component can communicate via the defined one or more channels.

13. The apparatus of claim 1, wherein the at least one non-transitory memory further comprises instructions that, when executed by the one or more processors, cause the one or more processors to:
generate a universal configuration hook comprising one or more error handling mechanisms, wherein the one or more error handling mechanisms are configured to manage exceptions encountered during data operations.

14. The apparatus of claim 1, wherein the candidate component is part of a third-party system.

15. The apparatus of claim 1, wherein the at least one non-transitory memory further comprises instructions that, when executed by the one or more processors, cause the one or more processors to:
generate, based on the one or more configurable adherence parameters, an adherence component library comprising a plurality of compliant components configured in accordance with the one or more configurable adherence parameters.

16. The apparatus of claim 1, wherein the one or more configurable adherence parameters comprise one or more display interface compliance parameters, and wherein the at least one non-transitory memory further comprises instructions that, when executed by the one or more processors, cause the one or more processors to:
determine, based on applying the one or more display interface compliance parameters of the one or more configurable adherence parameters to the one or more candidate component configuration elements, an interface adherence status for the candidate component.

17. The apparatus of claim 16, wherein the candidate component is an interface component, and the one or more display interface compliance parameters comprise one or more rendering behavior parameters, one or more data handling capability parameters, or one or more interaction pattern parameters with which the interface component must comply.

18. The apparatus of claim 1, wherein the at least one non-transitory memory further comprises instructions that, when executed by the one or more processors, cause the one or more processors to:
determine, based on the one or more configurable adherence parameters and one or more system compatibility statuses corresponding to one or more external components, an external system compatibility status corresponding to an external system comprising the one or more external components.

19. One or more non-transitory computer-readable storage media including instructions that, when executed by one or more processors, cause the one or more processors to:
receive, from a client device, a candidate component request comprising candidate component output data and one or more candidate component configuration elements associated with a candidate component;
determine, based on applying one or more component data ingestion parameters of one or more configurable adherence parameters to the candidate component output data, a component data ingestion protocol adherence status for the candidate component;
determine, based on applying one or more configuration element parameters of the one or more configurable adherence parameters to the one or more candidate component configuration elements, a configuration element protocol adherence status for the candidate component;
determine, based on one or more data outputs provided by one or more components of a subject web application system, one or more data transformation capabilities of the subject web application system;
determine, based on the component data ingestion protocol adherence status, the configuration element protocol adherence status, and the one or more data transformation capabilities of the subject web application system, a system compatibility status for the candidate component; and
configure, based on the system compatibility status for the candidate component, the subject web application system.

20. A computer-implemented method comprising:
receiving, by one or more processors from a client device, a candidate component request comprising candidate component output data and one or more candidate component configuration elements associated with a candidate component;
determining, by the one or more processors and based on applying one or more component data ingestion parameters of one or more configurable adherence parameters to the candidate component output data, a component data ingestion protocol adherence status for the candidate component;
determining, by the one or more processors and based on applying one or more configuration element parameters of the one or more configurable adherence parameters to the one or more candidate component configuration elements, a configuration element protocol adherence status for the candidate component;
determining, by the one or more processors and based on one or more data outputs provided by one or more components of a subject web application system, one or more data transformation capabilities of the subject web application system;
determining, by the one or more processors and based on the component data ingestion protocol adherence status, the configuration element protocol adherence status, and the one or more data transformation capabilities of the subject web application system, a system compatibility status for the candidate component; and
configuring, by the one or more processors and based on the system compatibility status for the candidate component, the subject web application system.
